(19) United States
(12) Patent Application Publication
(10) Pub. No.: US 2013/0192969 A1
(43) Pub. Date: Aug. 1, 2013

(54) SWITCHING APPARATUS FOR A LOW-VOLTAGE ELECTRICAL SWITCHING DEVICE

(71) Applicant: Kurt Haendler, Bonn (DE)

(72) Inventor: Kurt Haendler, Bonn (DE)

(73) Assignee: EATON INDUSTRIES GMBH, Bonn (DE)

(21) Appl. No.: 13/814,247

(22) PCT Filed: Aug. 5, 2011
(86) PCT No.: PCT/EP2011/063562

§ 371 Date: Mar. 22, 2013

(30) Foreign Application Priority Data
Aug. 6, 2010 (EP) 10172222.1

(51) Int. Cl. H01H 1/12

(52) U.S. Cl. CPC H01H 1/12
USPC 200/508

(57) ABSTRACT

A switching apparatus for a low-voltage electrical switch includes a rotary contact with switching pieces bearing at least two end contacts. The switching pieces are mounted at spatially variable pivot points. The rotary contact also includes a biasing member configured to apply a contact-pressure force. The switching apparatus also includes a housing and an arc quenching chamber.

### CROSS REFERENCE TO RELATED APPLICATIONS

This application is a U.S. National Phase application under 35 U.S.C. §371 of International Application No. PCT/EP2011/063562, filed on Aug. 5, 2011, and claims benefit to European Patent Application No. EP 10172222.1, filed on Aug. 6, 2010. The International Application was published in German on Feb. 9, 2012 as WO 2012/017090 A1 under PCT Article 21 (2).

### FIELD

The invention relates to a switching apparatus for a low-voltage electrical switching device.

### BACKGROUND

Switching apparatuses of this type conventionally comprise single interrupt or double interrupt contact arrangements.

EP 1 523 020 A1 discloses a switching apparatus comprising a single interrupt rotary contact, in particular for a multi-pole low-voltage load isolator switch. In this context, the switch comprises an insulating material housing, in which two chambers are formed, of which a first chamber acts as a quenching chamber and a second chamber of a comparable volume acts as a connection chamber. A single interrupt rotary contact is movable in a mounting, the rotary contact being in the form of a two-armed lever, the first lever arm of which bears a contact piece which comes into connective contact with a fixed contact on a first current connection rail. The second lever arm of the rotary contact is connected to a flexible conductor, which is conductively connected to a second current connection rail. Contact force springs are provided, and act on the rotary contact and a switching shaft or a switching shaft segment.

DE 100 61 394 A1 discloses a switching apparatus which contains a double interrupt rotary contact, which comprises a switch drive associated with each pole. The rotary contact is mounted, rotatably about an axis perpendicular to the longitudinal extent of the rotary contact, in mountings in the insulating material housing. The actual switch consists of two fixed contact pieces, which are connected to current rails, and a floatingly mounted rotatable contact piece, which is formed with two arms and bears end contacts which cooperate with the fixed contact pieces. Two contact-pressure springs, preferably in the form of torsion springs, are braced against a mounting bolt on the rotary contact piece and each exert a torque, directed in a closing movement, on the rotary contact piece.

The known switching apparatuses thus comprise a fixed contact and a movable contact piece. The fixed contact defines the isolating distance to be achieved between the contacts. In direct current (DC) applications, large isolating distances are desired. In the prior art, conventional switching apparatuses, which are configured for alternating current (AC) applications, are used for DC applications. So as to provide the necessary large contact distances, the two current paths which are present are connected in series. Therefore, a four-pole AC switching device in which two phases are connected in series in each case, for example Moeller load isolator switches for 1000 V DC such as N2-4-160-S1-DC to N4-4-1400-S1-DC, may be used so as to provide a DC switching apparatus using an existing switching device. The drawbacks of solutions of this type relate to the large space required by 4-pole switching devices of this type, the high costs, in particular as a result of doubling the necessary contact plates which generally consist of silver alloys, and the blowing action, which is not adapted to the DC application, of the contact arrangement on the arcs which occur in the event of switching or triggering.

### SUMMARY

In an embodiment, the present invention provides a switching apparatus for a low-voltage electrical switch includes a rotary contact with switching pieces bearing at least two end contacts. The switching pieces are mounted at spatially variable pivot points. The rotary contact also includes a biasing member configured to apply a contact-pressure force. The switching apparatus also includes a housing and an arc quenching chamber.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic drawing of the switching apparatus in the ON position,

FIG. 2 is a schematic side view of the switching apparatus in the OFF position, and

FIG. 3 is a schematic sectional plan view of the switching apparatus.

### DETAILED DESCRIPTION

An aspect of the present invention is to provide a switching apparatus for a low-voltage electrical switching device, in particular for DC applications, which overcomes the drawbacks of the known apparatuses.

A switching apparatus according to an embodiment of the invention is distinguished in that there are two movable switching pieces for each phase. The two switching pieces of a phase are mounted in the housing of the switching apparatus by way of a lever system. In this context, this lever system in each case comprises a guide lever and a pivot lever, which are each fixed to a rigid shaft on the housing on the switching apparatus and to a movable shaft on the respective switching piece. In the event of switching off, the pivot lever is moved from the ON to the OFF position and thus pivots the two switching pieces away from one another. The switching apparatus is therefore particularly suitable for DC and high voltages, for which large opening distances are required for switching off.

According to embodiments of the invention, the levers are connected to the switching pieces via movable articulations in such a way that the articulations move in arcs in the event of switching.

In a preferred embodiment of the invention, the levers are made of insulating material.

In a further embodiment, the levers comprise a core and a casing. In this case, the core material may consist of a heavy-duty material such as steel or aluminium. In this case, the casing material may consist of insulating material.

In a further preferred embodiment, contact force springs act on the pivot lever. It has been found to be advantageous to configure the contact force springs as extension springs which, in the ON position, exert a force on the contact pieces which acts towards the respective other contact piece.

In an advantageous embodiment, the switching pieces comprise contact plates on a first end.

In a particularly preferred embodiment, the curved path followed by the contact plates during the switching movement thereof is accompanied by a quenching chamber. It has been found to be particularly advantageous to configure this quenching chamber continuously over the entire curved path followed by the contact plates.

The switching apparatus according to the invention is suitable for alternating current applications, but also particularly for direct current applications.

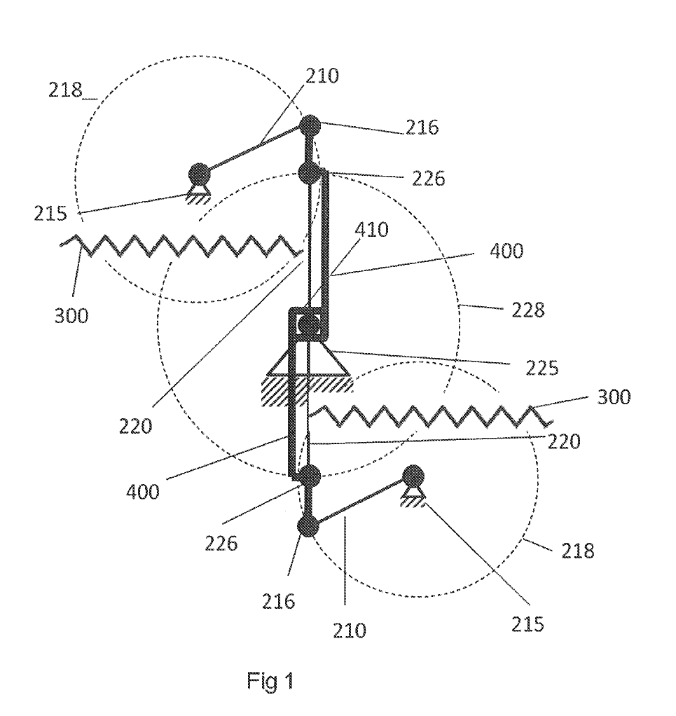

FIG. 1 is a schematic drawing showing the switching apparatus (100) according to the invention in the ON position. The switching apparatus (100) contains two movable switching pieces (400), which are each mounted movably on a first end of a guide lever (210) and of a pivot lever (220) in mountings comprising movable shafts (216, 226). The respective second ends of the guide levers (210) and the pivot levers (220) are each mounted in a housing (not shown) by means of a mounting comprising a rigid shaft (215, 225). The movable shafts of the guide levers (216) can move in space on a circular path (218) about the guide lever mounting of said guide levers which comprises a rigid shaft (215). The movable shafts of the pivot levers (226) can also move on a circular path (228) about the pivot lever mounting of said pivot levers which comprises a rigid shaft (225). The contact force is applied by means of contact force springs (300), which act on the pivot levers (220). However, it is also possible to have the contact force springs (300) act on other locations on the pivot levers (220) or on the switching pieces (400) themselves. In this case, the pivot lever (220) is shown in a simplified form, so as to depict the rigid connection of the pivot points (225) and (226). In some embodiments, this function is implemented by a switching shaft. The guide lever (210), and also the pivot lever (220), may be made of insulating material. However, it is also possible to produce the guide lever (210) and the pivot lever (220) from a sandwich comprising a core and a casing, it being possible for the core material to be a mechanically stable material, which need not be insulating, and for the casing material to consist of an insulating material.

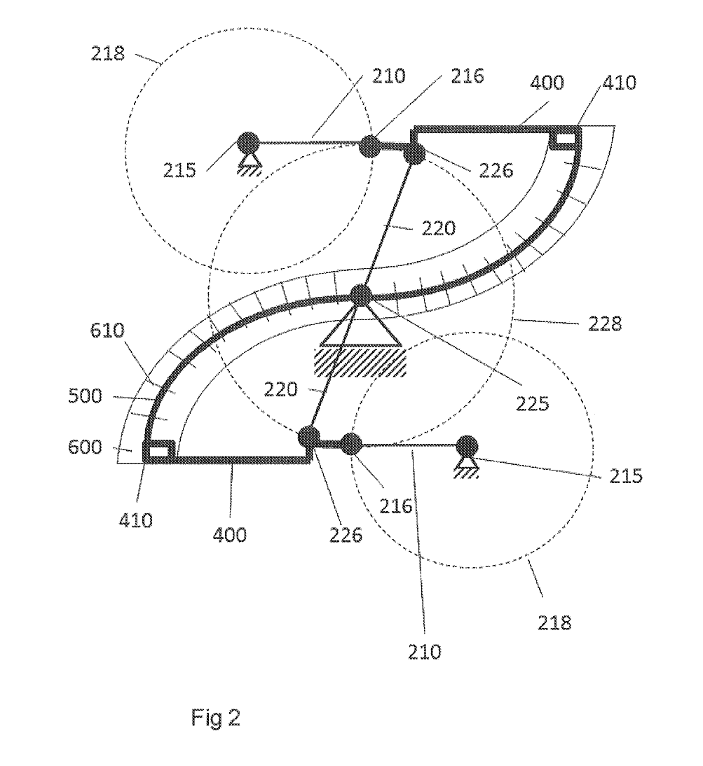

FIG. 2 is a schematic drawing depicting the switching apparatus (100) according to the invention in the OFF position. The two switching pieces have rotated in space about the movable shafts of the guide lever and the pivot lever (216, 226), these movable shafts (216, 226) having moved accordingly on the circular paths (218, 228) thereof. Although the guide and pivot levers (210, 200) have only moved a little, the end contacts (410) of the switching pieces have moved a long way away from one another. Further, a continuous arc quenching chamber (600) may be seen along the curved path described by the end contacts (410) during the opening movement. Arc quenching elements (610) are arranged in the arc quenching chamber (600). These arc quenching elements (610) may comprise metal sheets, which divide and cool the arc and in the process draw energy therefrom so as to cause it to be extinguished. The arc (500), which occurs during switching at a corresponding current level, extends along this arc quenching chamber (600) from one contact plate to the other contact plate, in such a way that optimum arc quenching is possible. When the contacts are open, the arc forms a current loop with the switching piece (on both sides), and this current loop rapidly drives the arc into the quenching chamber and leads to the arc being extinguished.

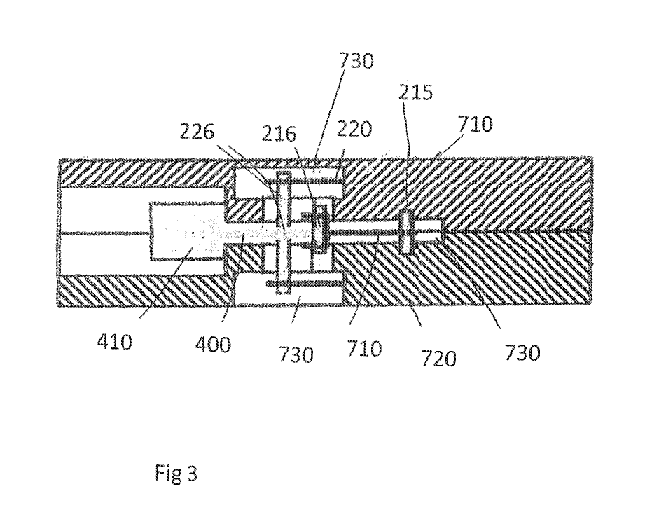

FIG. 3 is a schematic sectional plan view of a detail of the switching apparatus. The drawing shows parts of two housing halves (710, 720), the guide lever having rigid shafts (215) being mounted between these housing halves (710, 720). For each switching piece (400), the switching apparatus shown comprises a respective guide lever (210), which lies on the same longitudinal axis as the switching piece (400), and two respective pivot levers (220), the pivot levers (220) being arranged parallel to the longitudinal axis of the switching piece (400) and positioned to the side of the switching pieces (400). In the housing halves (710, 720), there are recesses (730) in which the levers (220, 210) and shafts (216, 226) can move. Together, the two housing halves (710, 720) form the housing of the switching apparatus, the isolation extending in the direction of the longitudinal axis of the switching pieces (400).

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### LIST OF REFERENCE NUMERALS

100 Switching apparatus for a low-voltage electrical switch
210 Guide lever
215 Guide lever mounting comprising rigid shaft
216 Movable shaft of the guide lever
218 Circle of the possible geometric locations of the movable shaft of the guide lever
220 Pivot lever
225 Pivot lever mounting comprising rigid shaft
226 Movable shaft of the pivot lever
228 Circle of the possible geometric locations of the movable shaft of the pivot lever
300 Contact force spring
400 Switching piece
410 End contact
500 Arc
600 Arc quenching chamber
610 Arc quenching elements
710 First housing half
720 Second housing half
730 Recess in housing for levers and shafts

1-8. (canceled)

9. A switching apparatus for a low-voltage electrical switch, the switching apparatus comprising:
a rotary contact including:
switching pieces bearing at least two end contacts, the switching pieces being mounted at spatially variable pivot points, and
a biasing member configured to apply a contact-pressure force;
a housing; and
an arc quenching chamber.

10. The switching apparatus for a low-voltage electrical switch according to claim 9, wherein the spatially variable pivot points each comprise a guide lever and a pivot lever.

11. The switching apparatus for a low-voltage electrical switch according to claim 10, wherein the guide lever and the pivot lever are each engaged with a spatially rigid shaft on the housing and with a spatially movable shaft on the switching piece.

12. The switching apparatus for a low-voltage electrical switch according to claim 9, wherein the guide lever and the pivot lever each comprise insulating material.

13. The switching apparatus for a low-voltage electrical switch according to claim 10, wherein the guide lever and the pivot lever each comprise insulating material.

14. The switching apparatus for a low-voltage electrical switch according to claim 11, wherein the guide lever and the pivot lever each comprise insulating material.

15. The switching apparatus for a low-voltage electrical switch according to claim 9, wherein the guide lever and the pivot lever each comprise a core and a casing, the casing comprising insulating material.

16. The switching apparatus for a low-voltage electrical switch according to claim 10, wherein the guide lever and the pivot lever each comprise a core and a casing, the casing comprising insulating material.

17. The switching apparatus for a low-voltage electrical switch according to claim 11, wherein the guide lever and the pivot lever each comprise a core and a casing, the casing comprising insulating material.

18. The switching apparatus for a low-voltage electrical switch according to claim 9, wherein the biasing member includes a contact force spring.

19. The switching apparatus for a low-voltage electrical switch according to claim 18, wherein the contact force springs are configured as extension springs.

20. The switching apparatus for a low-voltage electrical switch according to claim 9, wherein the arc quenching chamber is formed continuously over an entire opening path of the contact pieces.
